(19) United States
(12) Patent Application Publication
(10) Pub. No.: US 2008/0013560 A1
(43) Pub. Date: Jan. 17, 2008

(54) Data stream adapter

(76) Inventors: Francis Legray, Grenoble (FR); Salim Renane, Grenoble (FR)

Correspondence Address: Plevy Howard, PC, P.O. BOX 226, Fort Washington, PA, 19034, US

(21) Appl. No.: 11/827,950

(22) Filed: Jul. 13, 2007

(30) Foreign Application Priority Data
Jul. 13, 2006 (FR) 06/52965

(51) Int. Cl. H04L 12/56

(52) U.S. Cl. 370/412

(57) ABSTRACT

An adaptation circuit receiving first data at the rate of a first request signal and providing second data corresponding to the first data at the rate of a second request signal, the circuit comprising a control device generating control data indicating one of three orders and likely to change at the rate of the first request signal; a processing device providing a third request signal based on the first request signal and on said control data, and generating, for each activation of the first request signal, zero, one or two activations of the third request signal according to said control data; and a FIFO-type memory storing the value of the first data introduced for each of the possible activations of the third request signal and providing second data on each activation of the second request signal.

### BACKGROUND OF THE INVENTION

1. Field of the Invention

The present invention relates to a circuit for adapting data flows, or frequency-adaptation circuit. An adaptation circuit is intended to receive data D1 at a frequency F1 representative of a signal or of a phenomenon and to provide, at a frequency F2 different from frequency F1, data D2 determined based on data D1, data D2 representing the same signal, or phenomenon, as data D1.

2. Discussion of the Related Art

An adaptation circuit corresponds to the block shown in FIG. 1.

In the case where frequency F2 is greater than frequency F1, and where ratio F2/F1 is equal to an integer N, the adaptation circuit may be formed by means of an interpolation device of ratio N. As an example, based on data D1, a conventional digital interpolation device provides intermediary data comprising 0s interposed between the initial values of data D1. The intermediary data then pass through a digital low-pass filter which delivers data D2.

In the case where frequency F2 is lower than frequency F1, and ratio F1/F2=N, N being an integer, the adaptation circuit may be formed by means of a decimation device of ratio N. As an example, a conventional digital decimation device performs a digital filtering of data D1, then suppresses (N-1) samples out of N to provide data D2.

In the case where the ratio of frequencies F2 and F1 is not integral, a simple decimation or a simple interpolation is not possible.

FIG. 2 illustrates a known adaptation circuit in the case where F2/F1=P/N, where P and N are integers. The circuit comprises in series an interpolation device 1 of ratio P and a decimation device 2 of ratio N. The interpolation device provides intermediary data D′ at a frequency F′ equal to P*F1.

In all the above-described cases, it is necessary to have a clock signal Clk, of frequency Fck, to control the execution of the interpolation or decimation devices. It should be noted that frequency Fck must be greater than frequencies F1, F′, and F2 of data D1, D′, or D2, since the digital filters must generally perform several operations for each of the data.

In the simplest way, when the adaptation circuit belongs to an integrated circuit, clock signal Clk corresponds to the general integrated circuit clock signal. Such a general clock signal is conventionally obtained by means of a quartz.

In the case where frequencies F1 and F2 are integral sub-multiples of Fck, the above-mentioned adaptation circuits are easy to form. However, the frequencies Fck of the clock signals that can be obtained from a quartz come by a limited number. Further, there not always exists a quartz exhibiting a frequency which is an integral multiple of F1 and of F2.

Further, an adaptation circuit enabling receiving data D1 and/or providing data D2 of various frequencies is desired to be designed, it is not possible, for reasons of bulk and cost, to provide several quartzes corresponding to each of the possible frequencies F1 and F2.

A way to avoid use of multiple quartzes is to have a phase-locked loop circuit, or PLL. Such a circuit enables generating one or several clock signals based, for example, on the clock signal of the successive data D1.

However, a phase-locked loop circuit is generally very bulky and must be optimized for each type of integrated circuit manufacturing process.

Besides, the forming of a circuit such as shown in FIG. 2 may require a clock signal exhibiting a very high frequency Fck in the case where number P is high and frequency F′ of intermediary data D′ is high. Further, the greater P and N, the greater the size of the interpolation and decimation devices. In practice, this type of circuit is often improper for use.

### SUMMARY OF THE INVENTION

An object of the present invention is to provide an adaptation circuit which can be used whatever frequency ratio F2/F1.

Another object of the present invention is to provide such a circuit which can be made in the form of a digital circuit of easy design, whatever the used manufacturing process.

Another object of the present invention is to provide such a circuit which can receive and transmit data D1 and D2 exhibiting variable frequencies.

To achieve all or part of these objects, an aspect of the present invention provides an adaptation circuit receiving first data at the rate of a first request signal and providing second data corresponding to the first data at the rate of a second request signal, the circuit comprising a control device generating control data indicating at a given time one of the three possible orders, “suppress”, “transmit”, or “duplicate”, the delivered control data being likely to change at the rate of the first request signal; a processing device providing a third request signal based on the first request signal and on said control data, and generating, for each activation of the first request signal, zero, one or two activations of the third request signal according to whether said control respectively is “suppress”, “transmit”, or “duplicate”; and a FIFO-type memory storing the value of the first data introduced in a given activation of the first request signal for each of the possible corresponding activations of the third request signal and providing second data on each activation of the second request signal.

According to an embodiment of the present invention, the circuit further comprises an interpolation or decimation device receiving initial data and providing said first data.

According to an embodiment of the present invention, the circuit further comprises an interpolation or decimation device receiving the second data and providing output data.

According to an embodiment of the present invention, frequency F1 of the first request signal is greater than frequency F2 of the second request signal, frequency F1 being smaller than twice frequency F2.

According to an embodiment of the present invention, frequency F1 of the first request signal is smaller than frequency F2 of the second request signal, frequency F1 being greater than half frequency F2.

According to an embodiment of the present invention, said control data are a binary number that can take three different values each corresponding to one of said three possible orders.

According to an embodiment of the present invention, the first request signal and/or the second request signal are generated by a request generation device comprising a counter synchronized by a clock signal exhibiting a frequency greater than the average activation frequency of the first request signal and/or of the second request signal.

Another aspect of the present invention provides an analog-to-digital converter comprising an adaptation circuit such as previously defined.

Another aspect of the present invention provides a digital-to-analog converter comprising an adaptation circuit such as previously defined.

Another aspect of the present invention provides an integrated circuit comprising an adaptation circuit such as previously defined.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1, previously described, is a general diagram of a data flow adaptation circuit;

FIG. 2, previously described, shows a conventional embodiment of an adaptation circuit in the case where the ratio of the frequencies of the received and transmitted data is not integral;

FIG. 3 shows an embodiment of an adaptation circuit in the case where the frequency ratio of the received and transmitted data is not integral and where the general clock signal is not a multiple of the frequency of the received data;

FIG. 4 is a diagram illustrating the operation of a request generation device of the adaptation circuit shown in FIG. 3;

FIG. 5 shows an embodiment of an adaptation circuit in the case where the frequency ratio of the received and transmitted data cannot be written as the ratio of two integers of moderate size;

FIG. 6 is a diagram of an adaptation circuit according to the present invention;

FIG. 7 is a diagram of an embodiment of a decoder comprised in the processing device of the adaptation circuit shown in FIG. 6;

FIG. 8 is a diagram illustrating the operation of the adaptation circuit shown in FIG. 6;

FIG. 9 is a diagram of a device for controlling the adaptation device shown in FIG. 6;

FIG. 10 is a diagram of an adaptation circuit using a circuit according to the present invention;

FIG. 11 is a diagram of an analog-to-digital converter using an adaptation circuit according to the present invention; and

FIG. 12 is a diagram of a digital-to-analog converter using an adaptation circuit according to the present invention.

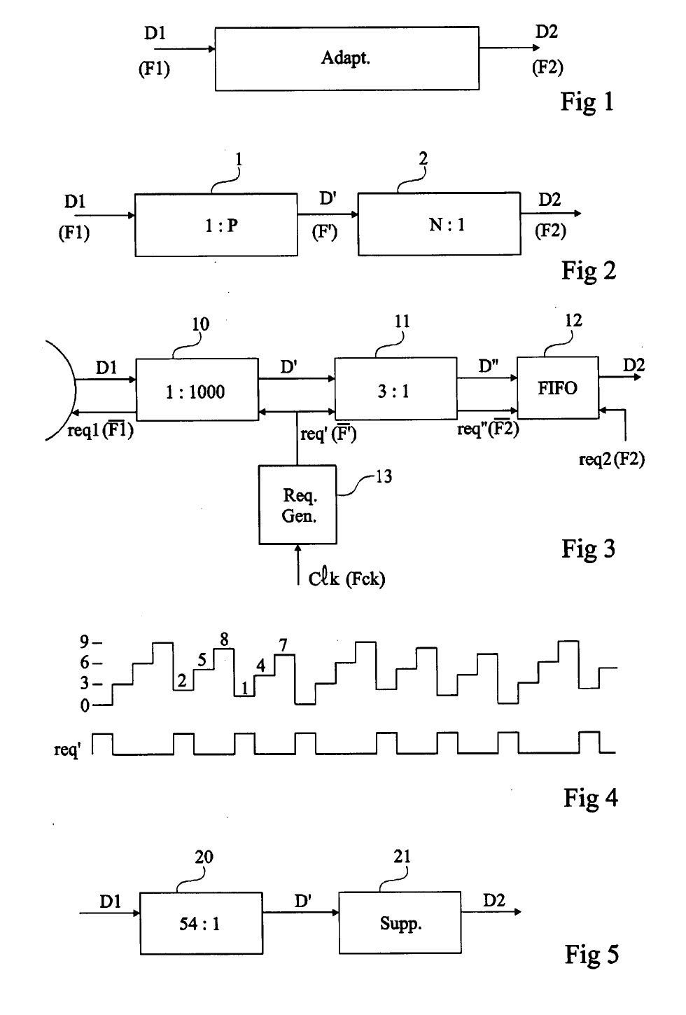

### DETAILED DESCRIPTION

For clarity, same elements have been designated with same reference numerals in the different drawings.

The adaptation circuits described in the following description use a “general” clock signal Clk, of frequency Fck. Clock signal Clk, or clock signals derived from Clk and exhibiting frequencies equal to sub-multiples of Fck, are used by the adaptation circuits to rate the operations performed by their various devices.

Further, in the following description, term “data D1 or D2” and term “data signal D1 or D2” will indifferently be used. Each of the data considered herein is formed of one or several bits. A data signal for example corresponds to an audio or video signal.

The different aspects which have been studied by the applicant and which have enabled said applicant to design the adaptation circuit according to the present invention will now be described.

Existing adaptation circuits may be “adapted” or modified in the case where frequency F1 of the received data D1 and/or frequency F2 of the transmitted data D2 is not a sub-multiple of frequency Fck of clock signal Clk. For this purpose, a request system enabling receiving data D1 with a frequency in average equal to F1 and/or transmitting data D2 with a frequency in average equal to F2 is used. Such a modification will be more easily understood on reading of the following example.

FIG. 3 is a diagram of an adaptation circuit receiving data D1 exhibiting a frequency F1 equal to 3.6 kHz and transmitting data D2 with a frequency F2 equal to 1.2 MHz. Frequency Fck of clock signal Clk is equal to 12 MHz. F2 is an integral sub-multiple of Fck (F2=Fck/10) and F1 is not an integral sub-multiple of Fck. Further, ratio F2/F1 is equal to 1,000/3 and the adaptation circuit of FIG. 3 corresponds to a modification, or “adaptation”, of the circuit shown in FIG. 2, in the case where P=1,000 and N=3.

The adaptation circuit comprises an interpolation device 10 of ratio 1,000 which receives data D1 and provides data D′ to a decimation device 11 of ratio 3. Decimation device 11 provides data D″ to a memory 12 of first-in-first-out type, or FIFO. The operations of devices 10 and 11 are rated by a request signal req′ provided by a request generation device 13 receiving clock signal Clk. Further, interpolation device 10 provides a request signal req1 to the device providing data D1 so that said device provides data D1 at the rate of request signal req1. Decimation device 11 provides a request signal req″ which controls the storage of data D″ in FIFO memory 12. Further, the FIFO memory delivers data D2 to order of a request signal req2 generated, for example, based on clock signal Clk.

Request signals req1, req′, and req″ are “pseudo” clock signals, which are not “perfectly” periodic. The frequency of signals req1, req′, and req″ is in average respectively equal to a frequency F1, F′, and F2. Request signals req1 and req″ are generated from request signal req′ which has the highest average frequency, F′ being equal to 3.6 MHz (3/10*Fck).

FIG. 4 illustrates the operation of request generation device 13 of the adaptation circuit shown in FIG. 3. Device 13 is formed of a counter modulo 10 which increments its output after each activation of clock signal Clk by adding +3 to the previously-provided value. Thus, starting from 0, the counter successively takes the following values: 3, 6, 9, 2, 5, 8, 1, 4, 7, 0 and so on. On each “decrease” of the value provided by the counter, that is, when the counter passes from one of values 7, 8, or 9 to one of values 0, 1, or 2, an activation of request signal req′ is generated. In the other changes of values of the counter, no activation of signal req′ is performed. For a given counter cycle, from 0 to 0, the activations of signal req′ are generated with intervals successively equal to 4*Tck, 3*Tck, 3*Tck, where Tck=1/Fck. The average frequency of request signal req′ then is 3/10*Fck.

The use of such a request generation device enables getting rid of the constraints according to which clock signal Clk must have a frequency Fck equal to an integral multiple of frequencies F1 and F2.

It should be noted that FIFO memory 12 is not indispensable. This memory enables providing data D2 with a frequency “perfectly” equal to F2. However, if the device receiving data D2 can receive the latter at a frequency in average equal to F2, then it may be directly connected to decimation device 11.

Another constraint of existing adaptation circuits, that is, to have a ratio F2/F1 that can be written as P/N, with P and N being integers of moderate size, can be solved due to an adaptation circuit comprising an interpolation or decimation device and a regulation device performing periodic suppressions or duplications. An example of such an adaptation circuit is described hereafter.

FIG. 5 is a diagram of an adaptation circuit receiving data D1 with a frequency F1 equal to 2.4 MHz and transmitting data D2 with a frequency F2 equal to 44.1 kHz, the latter corresponding to the frequency of a signal provided/received by an audio disk (CD) reader. Frequency Fck of clock signal Clk is equal to 12 MHz. F1 is an integral sub-multiple of Fck (F1=Fck/5) and F2 is not an integral sub-multiple of Fck. Ratio F1/F2 is equal to 54.4217 and cannot be written as N/P, where N and P are integers of moderate size. The solution is the following.

The adaptation circuit comprises a decimation device 20 of ratio 54 which receives data D1 and provides data D′ to a regulation device 21 which provides data D2. Device 21 regularly suppresses one of the data from data series D′ to form data D2. More specifically, the frequency of data D′ is equal to F1/54, that is, 44.44 kHz. Ratio F2/F′ is equal to 0.99, that is, to 99/100. For 100 data received by regulation device 21, said device must provide 99 thereof. The regulation device thus suppresses one of the data every 100 received data.

A disadvantage of the adaptation circuit of FIG. 5 is that it introduces noise into data signal D2. The introduced noise has in this example a frequency F′/100, that is, 444 Hz. This noise is disturbing in the case where data signal D2 is an audio signal since the 444-Hz frequency is comprised in the useful spectral band of an audible signal substantially corresponding to range 20 Hz-20 kHz.

As appears from the reading of the above-described examples of adaptation circuits, each case requires a specific adaptation circuit type. The present invention provides a “universal” adaptation circuit that can be used whatever frequency ratio F2/F1 and whatever the ratio between frequency Fck of clock Clk and frequency F1 or F2.

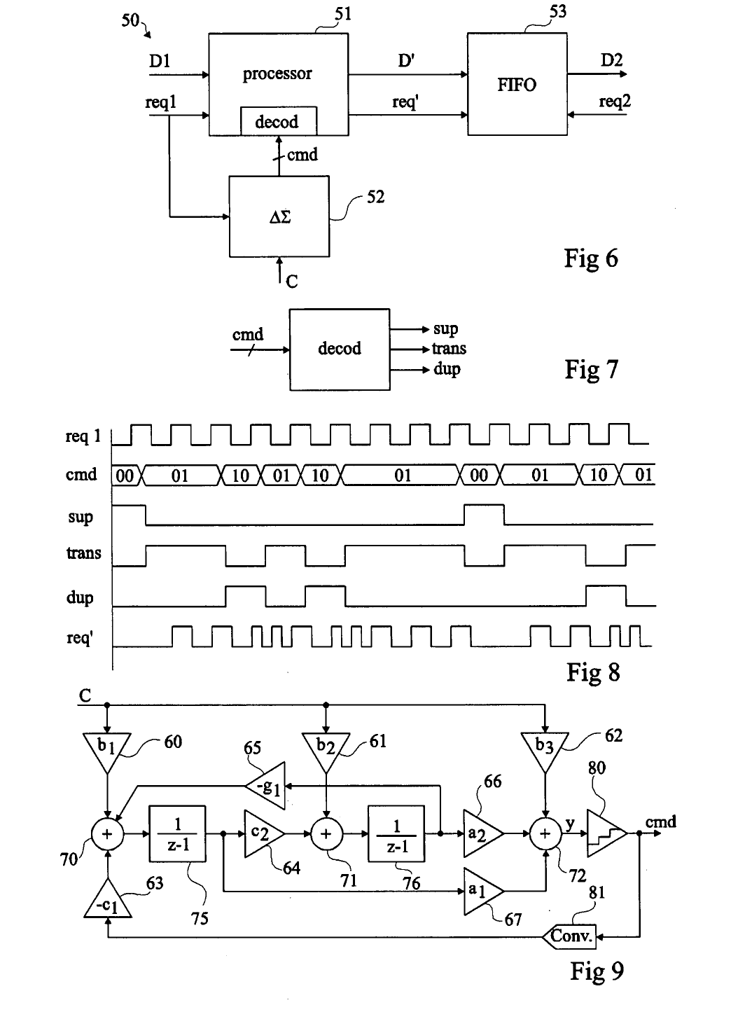

FIG. 6 is a diagram of an embodiment of an adaptation circuit 50 according to the present invention adapted to the case where F2 ranges between F1 divided by two (F1/2) and twice F1 (2F1). Circuit 50 comprises a processor 51, a ΔΣ control device 52, and a FIFO-type memory 53. Processing device 51 receives data D1 at the rate of the activations of a request signal req1. Processing device 51 provides data D′ and a request signal req′ to memory 53 which stores data D′ at the rate of the activations of request signal req′. FIFO memory provides data D2 at the rate of the activations of a request signal req2. ΔΣ control device 52 provides a control signal cmd to processor 51 and more specifically to a decoder comprised in processor 51. As for processor 51, the operation of ΔΣ control device 52 is rated by request signal req1. Control signal cmd provided by control device 52 is a function of the value of a number C defined according to frequencies F1 and F2. Number C can be obtained from the following relation:

$$C = \frac{F 2}{F 1} - 1 \qquad ( 1 )$$

in the case where F1 is the frequency (or the average frequency) of signal req1 and F2 is the frequency (or the average frequency) of signal req2.

FIG. 7 is a diagram of the decoder comprised in processing unit 51. Based on control signal cmd, the decoder generates three other signals: a suppression signal “sup”, a transmission signal “trans”, and a duplication signal “dup”.

The association of the processor and of the FIFO memory enables creating a data signal D2, from data signal D1, by suppressing a first portion of data D1, by copying a second portion of data D1, and by duplicating a third portion of data D1. The sequencing of the suppression, copy, and duplication operations is dictated by the control signal cmd provided by control device 52. Control signal cmd varies according to number C.

FIG. 8 is a diagram illustrating the operation of processor 51. Signals req1, cmd, sup, trans, dup, and req′ are shown. Signal req1 has in this example the form of a clock signal exhibiting a periodic alternation of two states “0” and “1”. Control signal cmd is a succession of binary values taken from among 3 following values “00”, “01”, and “10”. The possible changes of values of control signal cmd occur after a rising edge of signal req1. Each value of control signal cmd last for at least one cycle or, in other words, one period of signal req1. The control signal is in this example initially equal to 00, then equal to 01 for two cycles of signal req1, then equal to 10 for one cycle, then equal to 01 for one cycle, then equal to 10 for one cycle, then equal to 01 for three cycles, then equal to 00 for one cycle, then equal to 01 for two cycles, then equal to 10 for one cycle, then equal to 01 for one cycle. Suppression, transmission, and duplication signals “sup”, “trans”, and “dup” are active at level “1” when control signal cmd respectively has values 00, 01, and 10. Request signal req′ exhibits an alternation of states “0” and “1”. On each rising edge of request signal req1, processor 51 generates zero, one, or two activations of request signal req′ according to whether suppression signal “sup”, transmission signal “trans”, or duplication signal “dup” is respectively activated.

According to an alternative embodiment of processor 51, the generation of the activations of request signal req′ is performed on falling edges of request signal req1, that is, consecutively to the possible changes of control signal cmd. Those skilled in the art may devise other synchronization modes of request signal req′ with respect to request signal req1 and to control signal cmd, by for example using general clock Clk.

Data signal D′ may be a simple transmission of data signal D1. The value of data signal D′ must however not change too fast after a rising edge of request signal req1 so that a same data value D1 can be stored twice in FIFO memory 53 for two successive activations of signal req′, in case of a duplication order. In the case where this time constraint cannot be fulfilled by data signal D1, processor 51 copies data signal D1 on data signal D′ so that the changes of values of data signal D′ do not occur between two successive activations of signal req′ corresponding to a duplication order.

Control device 52 may be described as a pseudo-random control generator. The series of controls of signal cmd must be such that the obtained request signal req′ exhibits a frequency in average equal to frequency F2 of request signal req2. In the case where frequency F2 is greater than frequency F1, the number of duplications must be greater than the number of suppressions, and conversely.

Further, the performing of suppression and duplication operations introduces noise into data signal D2. However, the use as a control device of a circuit known as a ΔΣ circuit enables in the end introducing essentially high-frequency noise into data signal D2. Since the useful spectrum of data signal D2 is not infinite but limited to a “low-frequency” range, for example, 20 Hz-20 kHz for an audio signal, it is possible to provide a low-pass filter at the output of the adaptation circuit to suppress the introduced high-frequency noise if this noise is disturbing.

FIG. 9 is a diagram of an example of a digital ΔΣ circuit that can be used as a control circuit 52 in an adaptation circuit according to the present invention. The ΔΣ circuit comprises multiplication devices 60 to 67 represented by triangles in which are written multiplication factors, adders 70 to 72, as well as flip-flops 75 and 76 represented by squares in which 1/(z−1) is written. The ΔΣ circuit further comprises a comparator 80 and a converter 81.

Multiplication devices 60, 61, and 62 receive number C. Adder 70 receives the outputs of multipliers 60, 63, and 65. The output of adder 70 is connected to the input of flip-flop 75. The output of flip-flop 75 is connected to the inputs of multipliers 64 and 67. Adder 71 receives the outputs of multipliers 61 and 64. Flip-flop 76 receives the output of adder 71. The output of flip-flop 76 is connected to the inputs of multipliers 65 and 66. Adder 72 receives the outputs of multipliers 62, 66, and 67. Adder 72 delivers a signal y to comparator 80. Comparator 80 provides control signal cmd. Converter 81 receives signal cmd and its output is connected to the input of multiplier 63.

Numbers C and y, as well as all the other numbers processed by each of the elements of the ΔΣ circuit, are in this example coded over 20 bits. Number y varies within a predefined range of values, for example equal to 0-1.5. Comparator 80 generates a control signal cmd equal to 00, 01, or 10 respectively according to whether number y belongs to range of values [0;0.5[,[0.5;1[ or [1;1.5]. Converter 81 provides a number equal to 0, 0.5, or 1, respectively according to whether signal cmd is equal to “00”, “01”, or “10”.

According to relation (1), when number C is positive, this means that F2 is greater than F1. Conversely, when number C is negative, this means that F2 is smaller than F1. Number C is all the greater as ratio F2/F1 is high, knowing that F2 ranges between F1/2 and 2F1. Generally, the greater number C, the higher the ratio between the number of duplication control data “10” and the number of suppression control data “00”, and conversely.

The ΔΣ circuit shown in FIG. 9 is an even circuit of order 2. Other types of ΔΣ circuits may be used. Generally, the use of a ΔΣ circuit of high order enables ensuring that the noise is effectively pushed towards high frequencies, the value of the frequency beyond which the noise is pushed being at least partly determined by the selection of the coefficients of the ΔΣ circuit multipliers. As an example, in the field of audio signals, a ΔΣ circuit of order 4 may be used.

The adaptation circuit shown in FIG. 6 adapts to any type of frequency ratio F2/F1 when F2 ranges between F1/2 and 2F1. In the case where F2 is smaller than F1/2 or greater than 2F1, the adaptation circuit of FIG. 6 may be completed as follows.

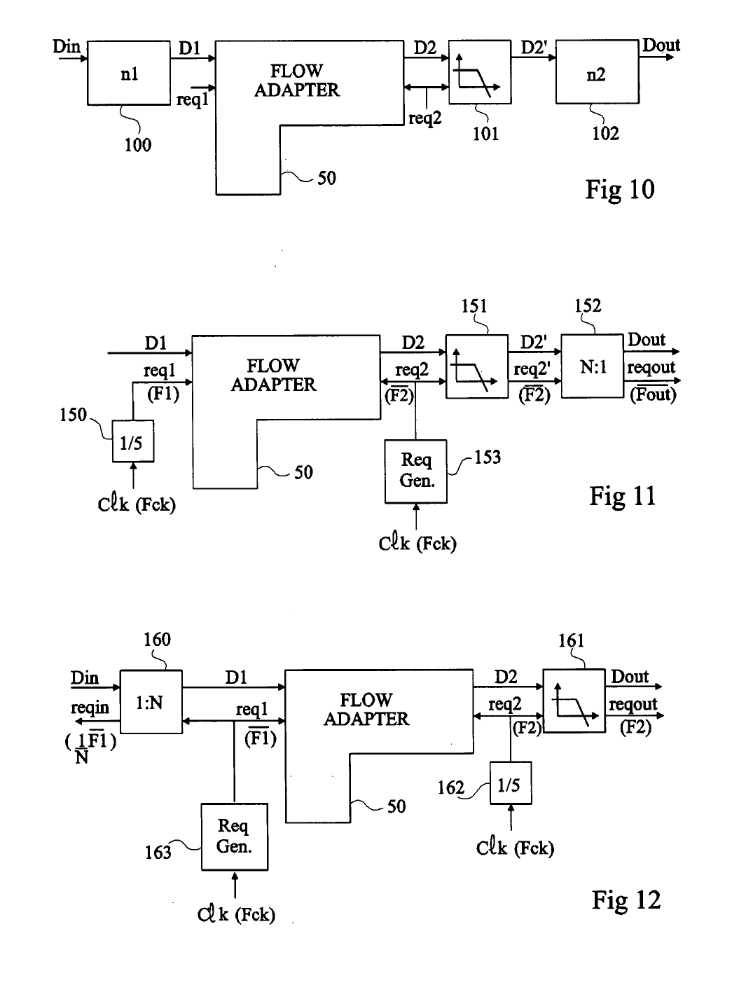

FIG. 10 is a diagram of an alternative embodiment of an adaptation circuit according to the present invention. This alternative embodiment comprises the adaptation circuit 50 shown in FIG. 6. An interpolation or decimation device 100 of ratio n1 receives data Din at a frequency Fin and provides data D1 to adaptation circuit 50. Data D2 provided by adaptation circuit 50 are transmitted to a low-pass digital filter 101. Filter 101 provides data D2′ to an interpolation or decimation device 102 of ratio n2. Device 102 provides data Dout at a frequency Fout.

Adaptation circuit 50 receives request signals req1 and req2 and filter 101 receives request signal req2. Devices 100 and 102 also receive and may provide request signals. The request signals are not shown since their arrival or departure “side” depends on the nature of devices 100 and 102, that is, whether it is a decimator or an interpolator. Further, since the request may have various origins, their origin is not specified in the drawing. The request signals may especially be generated from a general clock signal Clk by means, if necessary, of dividers or request generators similar to that previously described in relation with FIG. 4.

In the case where frequency Fin of the provided data is greater than frequency Fout of the transmitted data, devices 100 and 102 are decimation devices. Ratios n1 and n2 are selected so that F2 ranges between F1/2 and 2F1 so that adaptation circuit 50 operates properly. Further, ratio n1 is preferably selected so that F1 is sufficiently high to ensure an optimum operation of circuit 50.

In the case where frequency Fin is lower than frequency Fout, devices 100 and 102 are interpolation devices. Ratios n1 and n2 are similarly selected so that F2 ranges between F1/2 and 2F1 so that adaptation circuit 50 operates properly. According to a variation, it may also be provided to perform an oversampling step before adaptation circuit 50 and a decimation step after adaptation circuit 50 so that the adaptation performed by circuit 50 occurs at high frequencies.

In the circuit example shown in FIG. 10, two interpolation or decimation devices 100 and 102 are used. However, a single interpolation or decimation device placed before or after adaptation circuit 50 could be sufficient.

Filter 101 enables suppressing the high-frequency noise of data signal D2. It should however be noted that in case of use of a decimation device 102, comprising a low-pass filter, the presence of filter 101 is useless.

Further, ratios n1 and n2 may be provided to be variable to be able to convert data Din into data Dout whatever the ratio between frequencies Fout and Fin.

An advantage of an adaptation circuit according to the present invention is that it enables converting the data frequency whatever the desired conversion ratio between the frequencies of the received and transmitted data.

An adaptation circuit according to the present invention can be used in various circuits such as analog-to-digital converters or digital-to-analog converters.

FIG. 11 is a diagram of a portion of an analog-to-digital converter comprising adaptation circuit “FLOW ADAPTER” 50 show in FIG. 6. The converter operations are rated by a general clock signal Clk of frequency Fck, for example, equal to 12 MHz. Adaptation circuit 50 receives data D1 at the rate of a request signal req1 of frequency F1, equal in this example to 2.4 MHz, signal req1 being generated by a frequency-dividing circuit 150. Divider circuit 150 for example is a counter modulo 5 rated by clock signal Clk. Adaptation circuit 50 provides data D2 to a digital low-pass filter 151 which delivers data D2′ to a decimation device 152 of ratio N. Decimation device 152 delivers data Dout. Data D2 are provided by adaptation circuit 50 and processed by filter 151 at the rate of a request signal req2 generated by a device for generating requests 153 based on clock signal Clk. Request signal req2 exhibits a frequency in average equal to F2. Filter 151 provides decimation device 152 with a request signal req2′ exhibiting a frequency in average equal to F2. Decimation device 152 provides a request signal reqout having a frequency in average equal to a frequency Fout. The operating principle of request generator 153 may be similar to that of request generator 13 previously described in relation with FIG. 3.

Data D1 are for example digital data obtained after sampling of an audio or video signal, with a high frequency equal, in this example, to 2.4 MHz. Data Dout then correspond to a sampling of this same audio or video signal but with a lower frequency corresponding to the standard frequency of the audio or video signals stored on a disk (CD or DVD).

In the case where data Dout correspond to an audio signal recorded on CD, frequency Fout is equal to 44.1 kHz. Since this frequency is not a sub-multiple of Fck, it is thus necessary to use request generation device 153 to obtain signal req2 and thereby signal reqout. Decimation ratio N is then equal to 54 and frequency F2 corresponding to the average frequency of request signal req2 is 2.38 MHz. Frequency F2 is very close to frequency F1 equal to 2.4 MHz and adaptation circuit 50 operates in optimal conditions.

FIG. 12 is a diagram of a portion of a digital-to-analog converter comprising the adaptation circuit “FLOW ADAPTER” 50 shown in FIG. 6. The converter operations are rated by a general clock signal Clk of frequency Fck for example equal to 12 MHz. An interpolation device 160 of ratio N receives data Din at the rate of a request signal reqin and provides data D1 to adaptation circuit 50. A low-pass filter 161 receives data D2 provided by adaptation circuit 50 at the rate of a request signal req2 of frequency F2 and delivers data Dout at the rate of a request signal reqout of frequency Fout equal to frequency F2. Frequency F2 is for example equal to 2.4 MHz and request signal req2 is provided by a frequency-dividing circuit 162 rated by clock signal Clk. A request signal req1 having a frequency in average equal to a frequency F1 is provided to adaptation circuit 50 and to interpolation device 160 by a request generation device 163 receiving clock signal Clk. Interpolation device 160 delivers a request signal reqin exhibiting a frequency in average equal to F1/N. The operating principle of request generator 163 may be similar to that of request generator 13 previously described in relation with FIG. 3.

Data signal Din for example corresponds to an audio or video digital signal read from a CD or DVD. Data signal Dout then corresponds to a digital audio or video signal comprising a large number of samples that can easily be transformed into an analog audio or video signal by conventional conversion and amplification devices.

In the case where data Din correspond to an audio signal recorded on CD, frequency Fin, equal to 44.1 kHz, is not a sub-multiple of Fck and request generation device 153 is necessary to obtain signal req1 and thereby signal reqin. Interpolation ratio N is then equal to 54 and frequency F1 corresponding to the average frequency of request signal req1 is 2.38 MHz. Frequency F1 is very close to frequency F2 equal to 2.4 MHz and the adaptation circuit operates in optimal conditions.

It should be noted that in the above-mentioned examples of converters, data Dout of the analog-to-digital converter of FIG. 11 and data Din of the digital-to-analog converter of FIG. 12, intended for a recorder or originating from a CD or DVD reader, are provided or received at the rate of a request signal reqout or reqin which is not perfectly periodic. In the case where the recorders/readers cannot operate with non-periodic requests, a FIFO-type memory may be interposed between the recorder/reader and the converter.

Further, ratio N of decimation device 152 of the converter of FIG. 11 or of interpolation device 160 of the converter of FIG. 12 may be variable. The converters can thus receive and transmit signals of different frequencies.

Of course, the present invention is likely to have various alterations, improvements, and modifications which will readily occur to those skilled in the art. In particular, it will be within the abilities of those skilled in the art to devise other uses of the adaptation circuit according to the present invention and especially other analog-to-digital or digital-to-analog converters.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A adaptation circuit receiving first data at the rate of a first request signal and providing second data corresponding to the first data at the rate of a second request signal, the circuit comprising:
a control device generating control data indicating at a given time one of the three possible orders, “suppress”, “transmit”, or “duplicate”, the delivered control data being likely to change at the rate of the first request signal;
a processing device providing a third request signal based on the first request signal and on said control data, and generating, for each activation of the first request signal, zero, one or two activations of the third request signal according to whether said control respectively is “suppress”, “transmit”, or “duplicate”; and
a FIFO-type memory storing the value of the first data introduced in a given activation of the first request signal for each of the possible corresponding activations of the third request signal and providing second data on each activation of the second request signal.

2. The adaptation circuit of claim 1, further comprising an interpolation or decimation device receiving initial data and providing said first data.

3. The adaptation circuit of claim 1, further comprising an interpolation or decimation device receiving the second data and providing output data.

4. The adaptation circuit of claim 1, wherein frequency F1 of the first request signal is greater than frequency F2 of the second request signal, frequency F1 being smaller than twice frequency F2.

5. The adaptation circuit of claim 1, wherein frequency F1 of the first request signal is smaller than frequency F2 of the second request signal, frequency F1 being greater than half frequency F2.

6. The adaptation circuit of claim 1, wherein said control data are a binary number that can take three different values, each corresponding to one of said three possible orders.

7. The adaptation circuit of claim 1, wherein the first request signal and/or the second request signal are generated by a request generation device comprising a counter synchronized by a clock signal exhibiting a frequency greater than the average activation frequency of the first request signal and/or of the second request signal.

8. An analog-to-digital converter comprising the adaptation circuit of claim 1.

9. A digital-to-analog converter comprising the adaptation circuit of claim 1.

10. An integrated circuit comprising the adaptation circuit of claim 1.
